(19) United States
(12) Patent Application Publication
(10) Pub. No.: US 2004/0148051 A1
(43) Pub. Date: Jul. 29, 2004

(54) Modeling method and program for in-mold coating an injection molded thermoplastic article

(75) Inventor: Elliott J. Straus, Akron, OH (US)

Correspondence Address: David G. Burleson, Esq., OMNOVA Solutions, Inc., 175 Ghent Road, Fairlawn, OH, 44333-3300, US

(73) Assignee: Omnova Solutions, Inc.

(21) Appl. No.: 10/760,992

(22) Filed: Jan. 20, 2004

Related U.S. Application Data
(60) Provisional application No. 60/442,983, filed on Jan. 28, 2003.

(51) Int. Cl. B29C 39/00

(52) U.S. Cl. 700/198

(57) ABSTRACT

A modeling method for minimizing the cure time and flow time of a thermoset in-mold coating for a molded article. The minimization of cure time is based on determining the cure time as a function of mold temperature and initiator level. The method for minimizing flow time is based on predicting the fill pattern for a specific geometry mold. The methods are used to reduce cycle time in the preparation of in-mold coated parts and reduce defects in the appearance of the coating.

This application claims the benefit of prior U.S. Provisional Application No. 60/442,983, filed on Jan. 28, 2003.

### BACKGROUND

The present invention relates to a modeling method and computer program for in-mold coating a molded article or substrate formed from a thermoplastic resin with an in-mold coating composition. More particularly, the present invention relates to a method and program for improving the efficiency of the in-mold coating process by optimizing the injection location of the in-mold coating and minimizing cure time. The present invention finds particular application in the in-mold coating of thermoplastics. It is to be appreciated, however, that the invention may relate to other similar environments and applications.

Molded thermoplastic and thermoset articles, such as those made from polyolefins, polycarbonates, polyesters, polystyrenes and polyurethanes, are utilized in numerous applications including those for automotive, marine, recreation, construction, office products, and outdoor equipment industries. Often, application of a surface coating to a molded thermoplastic or thermoset article is desirable. For example, molded articles may be used as one part in multi-part assemblies; to match the finish of the other parts in such assemblies, the molded articles may require application of a surface coating that has the same finish properties as the other parts. Coatings may also be used to improve surface properties of the molded article such as uniformity of appearance, gloss, scratch resistance, chemical resistance, weatherability, and the like. Also, surface coatings may be used to facilitate adhesion between the molded article and a separate finish coat to be later applied thereto.

Numerous techniques to apply surface coatings to molded articles have been developed. Many of these involve applying a surface coating to molded articles after they are removed from their molds. These techniques are often multi-step processes involving surface preparation followed by spray-coating the prepared surface with paint or other finishes. In contrast, IMC provides a means of applying a surface coating to a molded article prior to its ejection from the mold.

Historically, much work with IMCs has been done on molded articles made from thermosets. Thermosets such as, e.g., phenolics, epoxies, cross-linked polyesters, and the like, are a class of plastic composite materials that are chemically reactive in their fluid state and are set or cured by a reaction that causes cross-linking of the polymer chains. Once cured, subsequent heating may soften a thermoset but will not restore it to a fluid state.

More recently, there has been an interest in IMC articles made from thermoplastics. Thermoplastics are a class of plastic materials that can be melted, cooled to a solid form, and repeatedly re-melted and solidified. The physical and chemical properties of many thermoplastic materials, together with their ease of moldability, make them materials of choice in numerous applications in the automotive, marine, recreation, construction, office products, outdoor equipment and other fields.

Various methods have been used to apply coating to molded thermoset and thermoplastic articles. For example, the coatings can be sprayed onto the surface of an open mold prior to closing. However, spray coating can be time-consuming and, when the coating is applied using a volatile organic carrier, may require the use of containment systems. Other coating processes involve lining the mold with a preformed film of coating prior to molding. The drawback of this process is that, on a commercial scale, it can be cumbersome and costly.

Processes have also been developed wherein a fluid coating is injected onto and dispersed over the surface of a molded part and cured. A common method of injecting a fluid IMC onto the surface of a molded article involves curing (if a thermoset material) and cooling an article in the mold to the point that it has hardened sufficiently to accept the coating, reducing the pressure against the telescoping mold half to crack open or part the mold, injecting the fluid coating, and re-pressurizing the mold to distribute the coating over the surface of the molded article. The cracking or parting of the mold involves releasing the pressure exerted on the telescoping mold half to sufficiently move it away from the molded article, thereby creating a gap between the surface of the part and the telescoping mold half. The gap allows coating to be injected onto the surface of the part without needing to remove the part from the mold.

Other process, such as injection molding, requires that pressure on the movable mold half be maintained so as to keep the cavity closed and to prevent resin from escaping along the parting line. Further, maintaining pressure on the resin material during molding, which also requires keeping the cavity closed, often is necessary to assist in providing a more uniform crystalline or molecular structure in the molded article. Without such packing, physical properties of the molded article tend to be impaired.

In addition to the problem of resin escaping along the parting line, packing constraints can sometimes create other problems when an IMC composition is to be injected into a mold containing a molded article. Specifically, some commercially available IMCs are generally thermoset materials that cure by the application of heat. Curing of these compositions is often achieved through transfer of residual heat from the molded article. Were the coating composition to be injected after a molded article has been sufficiently packed to allow the mold to be depressurized and parted or cracked, the molded article may lack sufficient residual heat to cure the coating. Thus, for coating compositions designed to cure on an article, it is desirably injected prior to depressurizing the mold.

Because injection molding does not permit the mold to be parted or cracked prior to injection of the IMC composition into the mold cavity, the IMC composition must be injected under sufficient pressure to compress the article in all areas to be coated. The compressibility of the molded article dictates how and where the IMC composition covers it. The process of coating an injection molded article with a liquid IMC composition is described in, for example, U.S. Pat. No. 6,617,033 and U.S. Patent Publication Nos. 2002/0039656 A1 and 2003/0082344 A1.

It has been determined that there are several important considerations that must be accounted for when using a liquid in-mold coating to coat an injection molded thermoplastic article in order to ensure the production of an acceptable final part while minimizing the cycle time needed to produce each part. Two of these considerations include the time required for the IMC to sufficiently cure and the time required for the IMC to sufficiently flow around the substrate.

It would thus be helpful to develop a mathematical method for determining the optimal concentration of components in the IMC to minimize cure time as well as a method for predicting the flow of the IMC and determining the optimal IMC injection location in a mold to minimize the cycle time and reduce the potential for surface defects.

### BRIEF DESCRIPTION

Briefly, there is provided a method for minimizing the cure time for an in-mold coating comprising a thermoset for a molded article by a method including the steps of: gathering information on the reactivity of the thermoset; using said information to develop a theoretical kinetic model representing a cure rate of the thermoset as a function of temperature and an initiator level in the coating; fitting results obtained from the theoretical kinetic model to a metamodel of the cure time as a function of an initiator level and reaction temperature; and minimizing the cure time using the metamodel for a minimum specified flow time.

In a second aspect, there is provided a method for optimizing the location of an in-mold coating injection port in a mold so as to minimize the flow time for an in-mold coating to flow over at least a part of a molded article, the method including the steps of: predicting a coating fill pattern in the mold; and using the pattern to determine optimal placement of a coating injection nozzle so as to minimize the flow time for an in-mold coating to flow over at least a part of a molded article and to reduce the presence of surface defects in the coating.

### BRIEF DESCRIPTION OF THE DRAWINGS

The invention may take physical form in various components and arrangements of components, and in various steps and arrangements of steps. The drawings are only for purposes of illustrating preferred embodiments and are not to be construed as limiting the invention.

FIG. 1 is a side view of a molding apparatus having a movable mold half and a stationary mold half according to a preferred embodiment of the present invention.

FIG. 2 is a partial cross-sectional view of the molding apparatus of FIG. 1 showing the movable mold half and the stationary mold half wherein the movable mold half is in a closed position to form a mold cavity, the mold cavity includes orifices for receiving first and second composition injectors.

FIG. 3 is a perspective view of an in-mold coating dispense and control apparatus adapted to be connected to the molding apparatus of FIG. 1.

FIG. 4 is a flowchart showing a typical thermoplastic molding and IMC injection cycle.

FIG. 5 is a chart showing the pressure-volume-temperature (PVT) relationship of a typical thermoplastic.

FIG. 6 is a model for minimizing the cure time of an IMC subject to a required flow time.

FIG. 7 is chart showing the DSC scans for a commercial IMC having an initiator concentration of 2.5% at different temperatures.

FIG. 8 is a chart showing the DSC scans for a commercial IMC having an initiator concentration of 1.5% at different temperatures.

FIG. 9 is chart showing the experimental versus predicted conversion levels for a commercial IMC having an initiator concentration of 2.5% at two different temperatures.

FIG. 10 is chart showing the experimental versus predicted conversion levels for a commercial IMC having an initiator concentration of 1.5% at two different temperatures.

FIG. 11 is a contour plot showing cure time of an IMC as a function of mold temperature and initiator level.

FIG. 12 is a contour plot showing flow time for an IMC as a function of mold temperature and initiator level.

FIG. 13 is a flow chart showing the modeling of a thermoplastic/IMC process and the minimization of cure time.

FIG. 14 is a chart showing the comparison between the numerically solved pressure distribution and the analytically solved distribution at the end of the IMC filling stage.

FIG. 15 is a chart showing the comparison between the numerically solved packing pressure and the analytically solved packing pressure at the end of the IMC packing stage.

FIG. 16 is a representation of the 1-dimensional coating flow from a line injection port over a substrate.

### DETAILED DESCRIPTION OF THE INVENTION

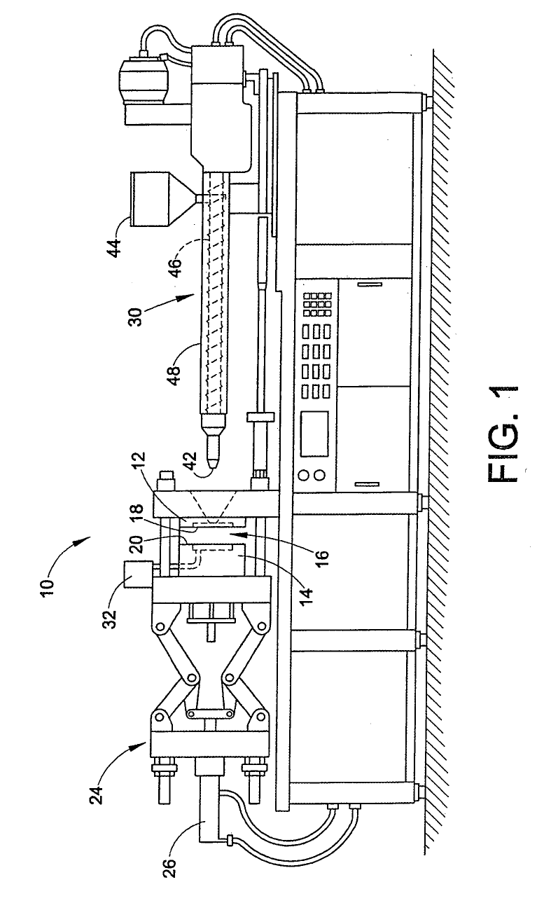

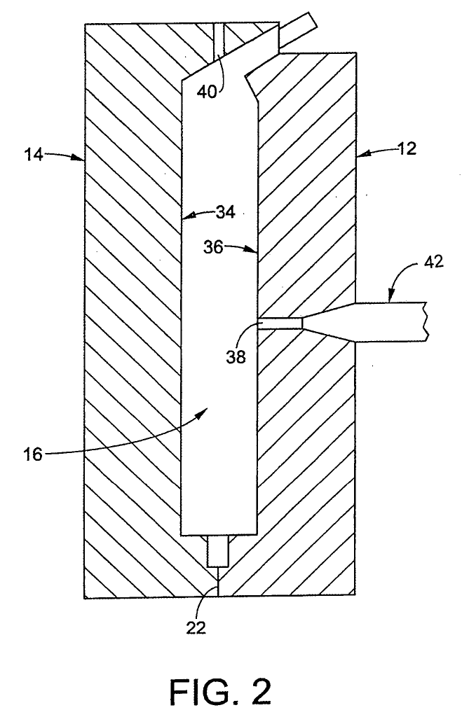

Referring now to the drawings wherein like reference characters represent like elements and which illustrate certain embodiments of the invention, FIG. 1 shows a molding apparatus or injection molding machine 10, which includes a first mold half 12 which preferably remains in a stationary or fixed position relative to a second moveable mold half 14. FIG. 1 shows movable mold half 14 in an open position. First mold half 12 and second mold half 14 are adapted to mate with one another to form a contained mold cavity 16 therebetween (See FIG. 2). Mold halves 12,14 mate along surfaces 18 and 20 (FIG. 1) when the molding apparatus is in the closed position, forming a parting line 42 (FIG. 2) therebetween and around mold cavity 16.

Movable mold half 14 reciprocates generally along a horizontal axis relative to mold half 12 by action of clamping mechanism 24 with clamp actuator 26 such as through a hydraulic, pneumatic or mechanical actuator as known in the art. Preferably, the clamping pressure exerted by clamping mechanism 24 should be capable of generating an operating pressure in excess of the pressures generated or exerted by either one of first composition injector 30 and second composition injector 32. For example, pressure exerted by clamping mechanism 24 can range generally from 14 MPa (about 2,000 psi) to about 103 MPa (about 15,000 psi), preferably from about 27 MPa (about 4,000 psi) to about 83 MPa (about 12,000 psi), and more preferably from about 41 MPa (about 6,000 psi) to about 69 MPa (about 10,000 psi) of the mold surface.

In FIG. 2, mold halves 12,14 are shown in a closed position abutting or mating with one another along parting line 42 to form mold cavity 16. The design of cavity 16 can vary greatly in size and shape according to the desired end product or article to be molded. Mold cavity 16 generally has a first surface 34 on the second mold half 14 and a corresponding or opposite second surface 36 on the first mold half 12. Mold cavity 16 also contains separate orifices 38,40 to allow composition injectors 30,32 to inject their respective compositions.

First composition injector 30 is that which is typical in an injection molding apparatus and is generally capable of injecting a thermoplastic or thermosetting composition, generally a resin or polymer, into mold cavity 16. Owing to space constraints, first injector 30 used to inject article-forming composition is positioned to inject material from fixed mold half 12, although first composition injector 30 could be reversed and placed in movable mold half 14. Second composition injector 32 is capable of injecting an IMC composition into mold cavity 16 to coat the molded article formed therein, although second composition injector 32 alternatively could be positioned in mold half 12.

In FIG. 1, first composition injector 30 is shown in a “backed off” position, but the same can be moved in a horizontal direction so that a nozzle or resin outlet 42 of first injector 30 mates with mold half 12. In the mated position, injector 30 is capable of injecting its contents into mold cavity 16. For purposes of illustration only, first composition injector 30 is shown as a reciprocating-screw machine wherein a first composition can be placed in hopper 44 and rotating screw 46 can move the composition through heated extruder barrel 48, where first composition or material is heated above its melting point. As the heated material collects near the end of barrel 48, screw 46 acts as an injection ram and forces the material through nozzle 42 and into mold cavity 16. Nozzle 42 generally has a valve (not shown) at the open end thereof and screw 46 generally has a non-return valve (not shown) to prevent backflow of material into screw 46.

First composition injector 30 is not meant to be limited to the embodiment shown in FIG. 1 but can be any apparatus capable of injecting a flowable (e.g., thermoplastic or thermosetting) composition into mold cavity 16. For example, the injection molding machine can have a mold half movable in a vertical direction such as in a “stack-mold” with center injection. Other suitable injection molding machines include many of those available from Cincinnati-Milacron, Inc. (Cincinnati, Ohio), Battenfeld Injection Molding Technology (Meinlerzhagen, Germany), Engel Machinery Inc. (York, Pa.), Husky Injection Molding Systems Ltd. (Bolton, Canada), BOY Machines Inc. (Exton, Pa.) and others.

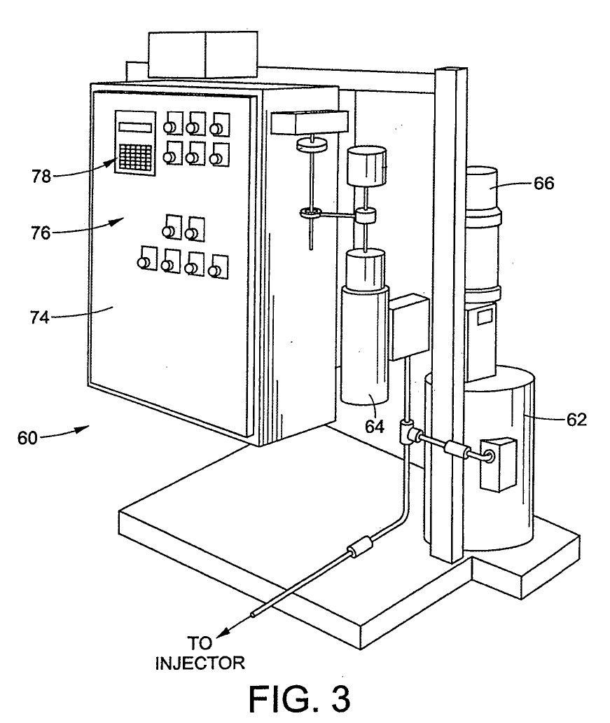

FIG. 3 shows an IMC dispense and control apparatus 80 adapted to be connected to molding apparatus 10 and provide IMC capabilities and controls therefor to the molding apparatus. Control apparatus 80 includes an IMC container receiving cylinder 82 for holding an IMC container such as a vat of an IMC composition. Suitable IMC compositions include those disclosed in U.S. Pat. No. 5,777,053. Control apparatus 80 further includes a metering cylinder or tube 84 that is adapted to be in fluid communication with the IMC container when received in the receiving cylinder 82. A transfer pump 86 is provided on control apparatus 80 and is capable of pumping IMC composition from receiving container 82 to metering cylinder 84.

Metering cylinder 84 is selectively fluidly connectable to second injector 32 on molding apparatus 10. Metering cylinder 84 includes a hydraulic means such as a piston for evacuating IMC composition from metering cylinder 84 and directing it to second injector 32. A return line (not shown) is connected to second injector 32 and to receiving container 82 to fluidly communicate therebetween.

Control apparatus 80 further includes an electrical box 94 capable of being connected to a power source. Electrical box 94 includes a plurality of controls 96 and a touch pad or other type of controller 98 thereon for controlling the dispensing of IMC composition to mold cavity 16. A compressed air connector (not shown) is provided the control apparatus 80 for connecting apparatus 80 to a conventional compressed air line. Compressed air is used to drive transfer pump 86 and remove IMC from control apparatus 80 and its fluid communication lines during a cleaning operation. Additionally, air can be used to move solvent through the communication lines for cleaning purposes.

Dispense and control apparatus 80 may include a remote transmitter (not shown) adapted to be positioned, in preferred embodiment, on one of mold halves 12,14. The transmitter may be, for example, a conventional rocker switch that sends a signal to apparatus 80 upon actuation. The transmitter may be positioned on one of mold halves 12,14 such that it is actuated upon closure of mold halves 12,14. The signal sent from the transmitter is used to initiate a timer (not shown) on control apparatus 80.

Alternatively, molding apparatus 10 may be equipped with a transmitter or transmitting means that has the ability to generate a signal upon closure of mold halves 12,14. A conventional signal transfer cable can be connected between molding apparatus 10 and control apparatus 80 for communicating the signal to control apparatus 80. Such an arrangement eliminates the need for an independent transmitter to be connected to one of mold halves 12,14.

Alternatively or in addition to the transmitter, control apparatus 80 may include at least one remote sensor (not shown) adapted to be positioned on one of mold halves 12,14 or otherwise adjacent to mold cavity 16 to record or measure the internal pressure and/or temperature within mold cavity 16. This sensor can be any known type of such sensor including, for example, a pressure transducer, thermocouple, etc. The sensor(s) and control apparatus 80 are operatively connected via conventional means to allow measurement signals to pass therebetween.

To prepare for injection of IMC composition into the mold cavity, a container of a desired IMC composition is placed in receiving cylinder 82. Metering cylinder 84 is fluidly connected to second injector 32. Return line 88 is fluidly connected to second injector 32 and receiving cylinder 82. The control apparatus 80 is connected to a suitable power source such as a conventional 460 volt AC or DC electrical outlet to provide power to electrical box 94. The remote sensor is appropriately positioned on one of mold halves 12,14 as described above.

To make an in-mold coated article, with reference to FIG. 1, a first composition is placed in the hopper 44 of the molding apparatus 10. First injector 30 is moved into nesting or mating relation with fixed mold half 12. Through conventional means, i.e., using heated extruder barrel 48 and rotating screw 46, first injector 30 heats the first composition above its melting point and directs the heated first composition toward nozzle 42 of first injector 30. Mold halves 12,14 are closed thereby creating mold cavity 16. The transmitter, if present, is positioned on one of mold halves 12,14 such that, when they are closed, the transmitter sends a signal to control apparatus 80 indicating that mold halves 12,14 are closed and that the molding process has begun. Upon receipt of this signal, hereinafter referred to as T₀, dispense and control apparatus 80 initiates the timer contained therein, which tracks elapsed time from T₀. At predetermined elapsed time intervals, control apparatus 80 actuates and controls various IMC related functions to ensure that the IMC composition is delivered to mold cavity 16 at a desired point in the molding process. Thus, control apparatus 80 operates concomitantly with molding apparatus 10.

After T₀, the molding process continues and a nozzle valve (not shown) of nozzle 42 is moved to an open position for a predetermined amount of time to allow a corresponding quantity of the first thermoplastic composition to enter mold cavity 16 through orifice 38. Screw 46 provides a force or pressure that urges the first composition into mold cavity 16 until the nozzle valve returns to its closed position. The first composition fills mold cavity 16. Once mold cavity 16 is filled and packed, the first composition is allowed to cool to a temperature below its melting point. The first composition does not cool uniformly, with the material that constitutes the interior of the molded article generally remaining molten while the material that constitutes the surface begins to harden as it cools more quickly.

After injection, the resin in mold cavity 16 begins to solidify, at least to an extent such that the substrate can withstand injection and/or flow pressure subsequently created by introduction of the coating composition. During this solidification, the forming article cools somewhat, and this is believed to result in at least a slight shrinkage, i.e., a small gap between the forming article and surfaces 34 and 36. Clearly, some type of active movement of surfaces 34 and 36 from the forming article could be undertaken but has not proven necessary. A predetermined amount of coating composition is utilized so as to provide a coating having, for example, a desired thickness and density.

As described above, allowing the surface of the substrate to sufficiently cool and harden such that the IMC composition and the first composition do not excessively intermingle. Also, the longer the time period between the end of the first composition filling and the coating injection, generally the lower the packing pressure needed to inject the coating composition and the easier the injection. However, because the IMC composition generally relies on the residual heat of the cooling article to cure, one risks inadequate curing of the IMC composition if the waiting period is too long. In addition, the article-forming material needs to remain sufficiently molten both to allow for sufficient adhesion between the IMC and the substrate as well as to provide sufficient compressability to allow adequate flow of the IMC around the surface of the substrate (i.e. article) in the mold. Thus, the ease of coating injection needs to be balanced with the need for sufficient residual heat to obtain an adequate curing of the IMC composition.

After the first composition has been injected into mold cavity 16 and the surface of the molded article to be coated has cooled below the melt point or otherwise reached a temperature or modulus sufficient to accept or support a coating composition but before the surface has cooled so much that curing of the IMC composition is inhibited, a predetermined amount of an IMC composition is ready to be introduced into the mold cavity from orifice 40 (FIG. 2) of second composition injector 32.

The point in the molding process when the IMC composition is injected, hereinafter referred to as T_{IMC}, can be characterized as an elapsed time from T₀. For the second injector 32 to inject the IMC composition precisely at T_{IMC}, control apparatus 80 must perform several functions at precise times between T₀ and T_{IMC}. Each of these functions occurs at a predetermined elapsed time relative to T₀. One such function is filling metering cylinder 84 with a desired amount of IMC composition. This function occurs in advance of T_{IMC}. Thus, at the preselected elapsed time, control apparatus 80 opens a valve (not shown) that permits fluid communication between the IMC composition-filled container and metering cylinder 84. Transfer pump 86 then pumps coating composition from the container to metering cylinder 84. When metering cylinder 84 is filled a desired amount, the valve closes to prevent more IMC from entering cylinder 84. The amount of IMC composition permitted to enter cylinder 84 is selectively adjustable.

After cylinder 84 is filled and just prior to T_{IMC}, control apparatus 80 opens a pin or valve (not shown) on second injector 32 to allow fluid communication between second injector 32 and mold cavity 16. The valve is normally biased or urged toward a closed position, i.e., flush to the mold surface, but is selectively movable toward the open position by control apparatus 80. Specifically, for example, an electrically powered hydraulic pump (not shown) of control apparatus 80 is used to move the valve. Immediately or very shortly thereafter, at T_{IMC}, the hydraulic means of cylinder 84 evacuates the IMC composition contained therein and delivers it to second injector 32 where it passes through orifice 40 and into mold cavity 16.

The IMC composition is injected into the mold cavity at a pressure ranging generally from about 3.5 to about 35 MPa, desirably from about 10 to about 31 MPa, and preferably from about 13.5 to about 28 MPa.

Once coating composition has been injected into mold cavity 16, second injector 32 is deactivated, thus causing flow of coating composition to cease. The coating composition flows around the molded article and adheres to its surface. Curing or crosslinking of the coating composition can be caused by the residual heat of the substrate and/or mold halves, or by reaction of the composition components. The coating composition subsequently cures in the mold cavity and adheres to the substrate surface, thus forming a coating thereon. If the residual heat of the substrate is used to effect curing, the IMC composition is injected before the molded article has cooled to the point below where proper curing of the coating can be achieved. The IMC composition requires a minimum temperature to activate the catalyst or initiator present therein which causes a cross-linking reaction to occur, thereby curing and bonding the coating to the substrate.

As detailed above, the IMC composition preferably is injected soon after the surface of the molded article has cooled enough to reach its melt temperature. The determination of when the melt temperature is reached can be determined from time elapsed from T₀ based on results from previous trials using the same materials and mold conditions. Alternatively, if a temperature sensor is used in addition to or in place of the transmitter, the point at which the molding resin reaches its melt temperature can be determined directly by observation of the internal mold temperature if the melt temperature of a particular resin is known. Finally, this point can also be determined indirectly by observation of the internal mold pressure. As noted, when the molded part cools to its melt temperature and begins to solidify, it contracts somewhat, thus reducing the pressure in the mold, which may recorded through the use of a pressure transducer (not shown) in the mold.

In the above described process, the mold is generally not opened or unclamped before the IMC is applied. That is, the mold halves maintain a parting line and generally remain substantially fixed relative to each other while both the first and second compositions are injected into the mold cavity. The IMC composition spreads out from the mold surface and coats a predetermined portion or area of the molded article. Immediately or very shortly after the IMC composition is fully injected into mold cavity 16, the nozzle valve or deactivation means of second injector 32 is engaged, thereby preventing further injection of IMC composition into mold cavity 16.

IMCs are generally flexible and can be utilized on a variety of injection molded substrates, including thermoplastics and thermosets. Thermoplastic molding resins which can be used to make articles capable of being coated by means of the foregoing composition include acrylonitrile-butadiene-styrene (ABS), phenolics, polycarbonate (PC), thermoplastic polyesters, polyolefins including polyolefin copolymers and polyolefin blends, PVC, epoxies, silicones, and similar thermoplastic resins, as well as alloys of such molding resins. Preferred thermoplastic resins include PC and PC alloys, ABS, and alloy mixtures of PC/ABS. Exemplary useful alloy mixtures of PC/ABS ordinarily have a PC/ABS ratio of about 20/80 by weight.

Between IMC injections, control apparatus 80 uses transfer pump 86 to circulate IMC composition through the system. The valve on second injector 32 remains in its closed position thereby preventing any IMC composition from entering mold cavity 16. One purpose of circulating the IMC composition between cycles is to prevent any particular portion of the coating composition from becoming undesirably heated due to its proximity to heating mechanisms on molding apparatus 10. Such heating could detrimentally impact the material properties of the IMC or could solidify the IMC composition in the fluid lines.

Controls 96 and keypad 98 of control apparatus 80 enable an operator to adjust and/or set certain operating parameters of control apparatus 80. For example, the controls can be manipulated to increase or decrease the amount of IMC composition to be filled in cylinder 84 by allowing the valve that controls communication between cylinder 84 and receiving container 82 to remain open for a longer duration. Additionally, the controls can be manipulated to adjust the elapsed time from T₀ that cylinder 84 is filled by transfer pump 86 and/or the amount of time elapsed from T₀ that cylinder 84 is emptied by the hydraulic means. This time may be adjusted to more closely approximate T_{IMC}.

In an alterative embodiment, and as mentioned above, the sensor is a pressure transducer mounted adjacent mold cavity 16 and adapted to record a pressure in mold cavity 16. In this embodiment, the transmitter and timer of control apparatus 80 can be eliminated. Rather than using the time elapsed from T₀ to dictate when the mold processes are begun, in this embodiment control apparatus 80 injects IMC composition into mold cavity 16 based on the pressure recorded in mold cavity 16 by the pressure transducer sensor. The IMC composition is desirably injected into the mold cavity at the same point in the molding process, T_{IMC}, irrespective of what type of sensor is used. Thus, rather than being time dependent, this embodiment is pressure dependent.

Such control is possible because pressure in mold cavity 16 initially rises as molding resin fills mold cavity. The pressure rises more as the mold cavity is packed. Finally, the pressure in mold cavity 16 begins to decrease as the molded article cools and begins to solidify. At a predetermined pressure during the cooling phase that corresponds with T_{IMC}, the IMC composition is preferably injected into mold cavity 16. The predetermined pressure is generally based on the specific type of resin used and may also be based on the specific type of IMC composition used.

Based on pressure measurements taken by the pressure transducer sensor, the series of functions performed by control apparatus 80 also can be dependent on the pressure measured in mold cavity 16. Thus, each of the functions can occur at a predetermined pressure in mold cavity 16 so that the IMC composition can be injected into mold cavity 16 at the desired point in the molding process. Injecting IMC composition into mold cavity 16 onto the surface of a molded article based on the pressure measured in the mold cavity is generally described in commonly owned U.S. Pat. No. 6,617,033.

The term “transducer” is meant to cover any type of sensor or other means for measuring or recording a value for an associated variable. Thus, a pressure transducer alternatively can be a plurality of pressure sensors positioned at varying locations around mold cavity 16. In this arrangement, control apparatus 80 would perform its functions, including injecting the IMC composition, based on a plurality of pressure measurements. For example, control apparatus 80 could perform its functions based on predetermined averages of the plurality of pressure measurements taken by the sensors. This arrangement may be desirable because a plurality of pressure transducers may be able to better determine the actual pressure observed in mold cavity 16.

Alternatively or in addition to the previous embodiments, a temperature sensor can be used to determine when to inject the IMC composition. That is, once the temperature mold cavity 16 reaches a temperature below the known melt temperature of the material being used, the IMC composition can be injected.

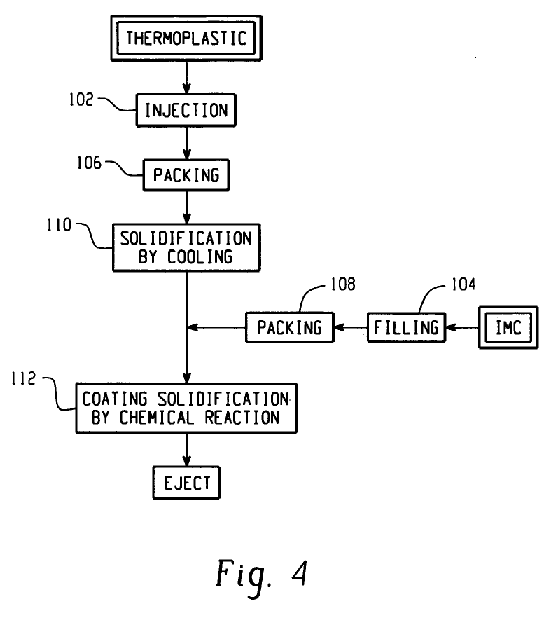

With reference to FIG. 4, the injection molding cycle for a thermoplastic and the coating cycle for an IMC can both generally be thought of as including three main stages: filling (or injection) 102, 104, packing 106, 108 and solidification that is due to cooling for the thermoplastic molding 110 and curing for the IMC 112. The coating material is injected 104 nto the mold while the thermoplastic is in the solidification stage 110. As the coating is injected into the mold under high pressure, it flows around the interior walls of the mold by compressing the thermoplastic substrate until the exterior surface of the thermoplastic substrate is completely covered. In order to obtain a desired coating thickness, more coating material is injected into the mold during the packing phase 108. The IMC solidifies during the curing stage 112.

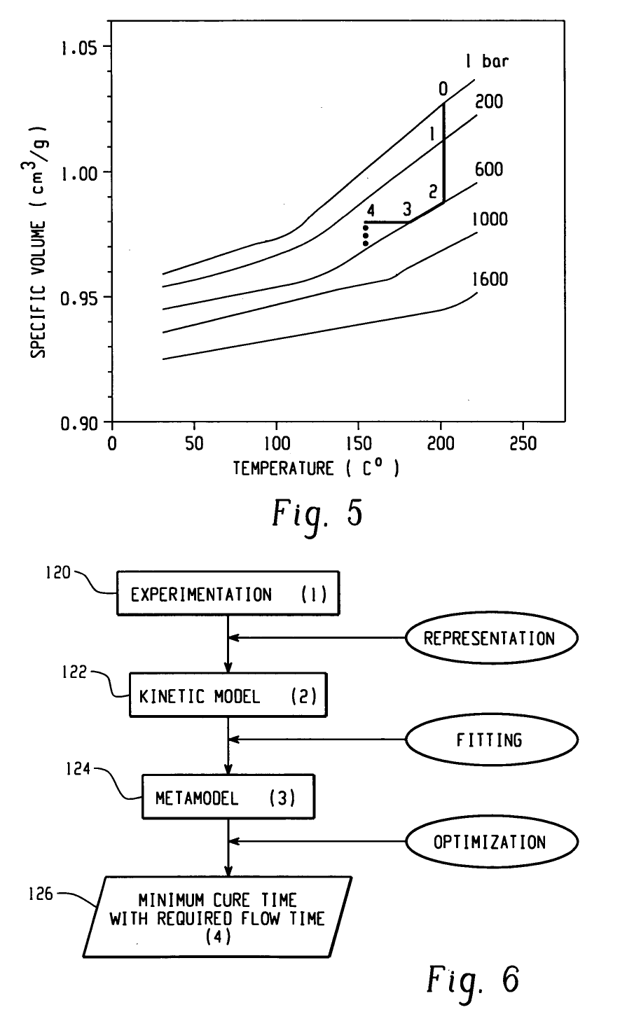

The pressure-volume-temperature (PVT) diagram for a typical thermoplastic is shown in FIG. 5. In the first step, the pressure in the mold rises at a relatively slow rate during the filling stage (0-1) as thermoplastic is injected. In the packing stage (1-2), the pressure in the mold increases at a greater rate as additional thermoplastic is injected into the mold and becomes compressed. This pressure is kept constant for a while to compensate for the material shrinkage as the thermoplastic begins to cool (2-3). Finally, in the cooling stage (3-4), the IMC is injected. Thermoplastic specific volume further decreases due to the higher coating injection pressure. Obviously, the exact decrease in pressure will depend on the PVT (pressure-volume-temperature) behavior of the specific thermoplastic material being processed.

As described above, the IMC coating should be injected during the cooling stage. The longer the period between the end of the thermoplastic filling and the coating injection, the lower the packing pressure needed to inject the coating and the easier the injection. However, because the IMC coating generally relies on the residual heat of the cooling thermoplastic to cure, one risks inadequate curing of the IMC coating if the waiting period is too long. Thus, the easiness of coating injection needs to be balanced with the need for a high enough temperature required to obtain an adequate curing of the coating. In addition, another property that is affected by the temperature decrease due to the delay before IMC injection is the adhesion of the coating to the thermoplastic substrate.

In order to optimize the injection process, the present invention develops a method to predict the injection pressure needed to inject the coating, the force (clamping tonnage) needed to avoid leakage, the fill pattern and optimal injection location to minimize the cycle time and the potential for trapped air, and the cure time. A mathematical method for modeling a specific geometry part is disclosed which can be extended to more complicated parts.

Minimization of IMC Cure Time

One of the most significant cost drivers in the polymer composites industry is the cycle time to produce a part. In IMC molding, it is especially important to minimize the cure time while allowing sufficient time for the IMC to completely cover the thermoplastic substrate (i.e. allow enough flow time).

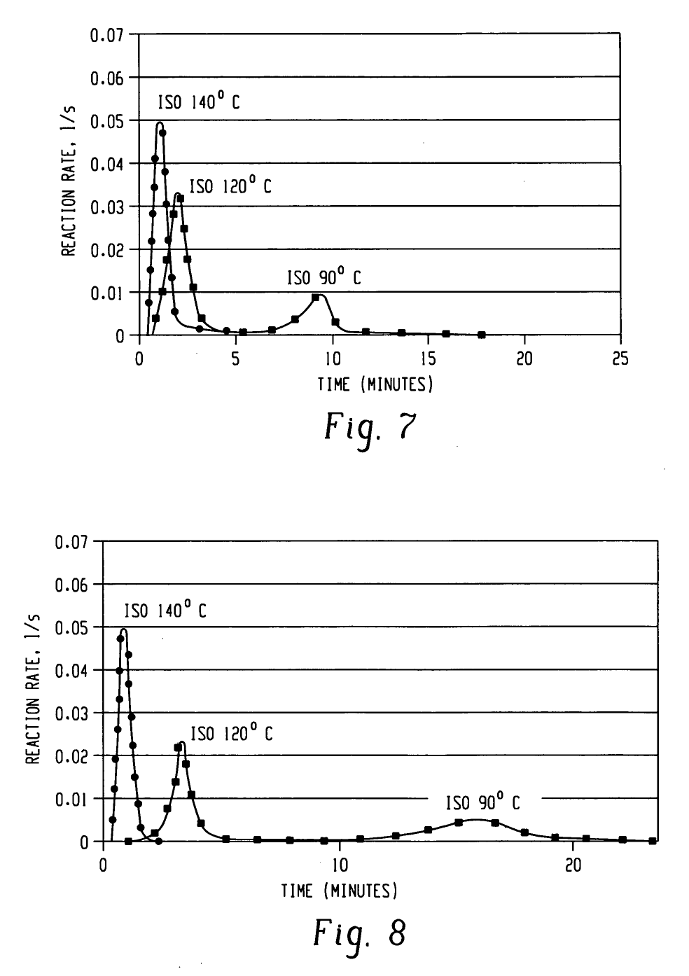

As shown in FIG. 6, four parts interact to make up the present method. In step 120, it is necessary to gather information on the reactivity (kinetics) of the IMC material. This information is easily obtained experimentally using a Differential Scanning Calorimeter (DSC). For example, FIGS. 7 and 8 show isothermal DSC scans for a commercial IMC having two different initiator (tert-butyl peroxide) concentrations at different temperatures. The resulting data is used to develop a mechanistic model to represent the reaction rate as a function of temperature and initiator level in step 122. In one embodiment, a free radical based kinetic model as suggested by Stevenson, J. F., Polym. Eng. Sci. 28, 746 (1986) and Lee, L. J., Polym. Eng. Sci. 21, 483 (1981) was used. The following are the assumptions of the model.

Only the initiator and one inhibitor are used in the system;

no monomer reacts until the number of initiator radicals created is equal to the effective number of inhibitor molecules initially present;

a single reaction rate constant characterizes all propagation reactions;

monomer diffusion control is less important; and

free radical termination is negligible.

An isothermal condition is assumed during IMC curing as well given the small thickness of the IMC. The equation for predicting the conversion (c*) of the monomer is thus given by:

$$\frac{ⅆ {c}^{*}}{ⅆ t} = {A}_{1} * {ⅇ}^{- \frac{Ep}{R * T}} * ( 1 - {c}^{*} ) * ( 1 - {ⅇ}^{- {k}_{d} * ( t - {t}_{z} )} ) \qquad ( 1 )$$

Where

A₁+2*f*k_{PO}*c₁₀*e^{-k}^{_{d}}^{*t}^{_{z}} (2)

And the equation for the inhibition time is:

$$ln {t}_{z} = ln ( - \frac{1}{{k}_{do}} * ln ( 1 - \frac{q * {c}_{zo}}{2 * f * {c}_{10}} ) ) + \frac{{E}_{d}}{R * T} \qquad ( 3 )$$

The kinetic parameters characterizing the model, that is, k_{d0}, E_{d}, Kₚ₀, and Eₚ, are obtained from isothermal DSC measurements such as the ones shown in FIGS. 7 and 8. The values of the parameters for the IMC used in these trials are given in Table 1. It should be understood that other kinetic models may be used without departing from the scope of the invention.

The data obtained from the design of experiments was later used to fit one metamodel per response, the metamodels being of the form

$$y = {β}_{0} + {\sum }_{i = 1}^{k} {β}_{i} {x}_{i} + {\sum }_{i = 1}^{k} {β}_{ii} {x}_{i}^{2} + {\sum }_{i = 1}^{k - 1} {\sum }_{j > 1}^{k} {β}_{ij} {x}_{i} {x}_{j} + ϵ β \qquad ( 4 )$$

where y is the measured response of interest, the β's are regression parameters, and the x's are the independent variables, which, in the present case, will denote the values in the horizontal axis and vertical axis on a part where an injection point is placed.

TABLE 1
Parameters Obtained from the Free Radical
Polymerization Model

| TBP | | | | | Predicted |
|---|---|---|---|---|---|
| level | E_{d} | k_{d0} | Eₚ | kₚ₀ | (q * C_{zo})/f |
| 0.5% | 48831.45 | 108.6387 | 121916.5 | 3.41e17 | 0.000242 |
| 1.0% | 34133.13 | 2.9746 | 145328.7 | 7.12e20 | 0.000284 |
| 1.5% | 34272.8 | 3.875 | 128526.1 | 6.12e18 | 0.000326 |
| 2.0% | 35007.76 | 5.0689 | 139708.5 | 2020e20 | 0.000368 |
| 2.5% | 34696.81 | 4.85 | 154016.9 | 4.14e22 | 0.00041 |

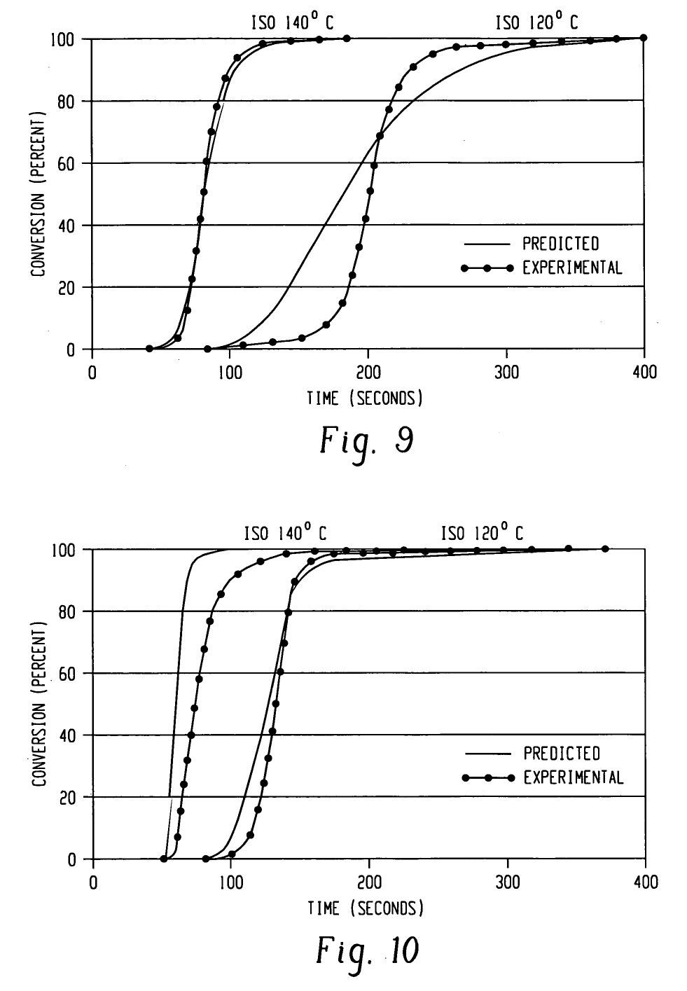

The reason for using the kinetic model instead of the DSC data to fit the meta model is that it is difficult to carry out experimental runs at the temperatures of interest. FIGS. 9 and 10 show a comparison of the predicted extent of reaction versus the experimental values obtained from DSC runs. FIG. 9 is for a tert-butyl peroxide catalyst concentration of 1.5% by weight while FIG. 10 is for 2.5% by weight.

The kinetic model is then used to generate two responses of interest, namely flow time (t_{f}) and cure time (t_{c}) at different combinations of the independent variables mold temperature (T_{w}) and initiator level (I_{L}). The flow time is the time before any reaction takes place and the cure time is defined as the time to reach 90% conversion.

It has been shown in the literature that the flow time can be assumed to be about half the time to finish all the inhibitor. The set of predictions obtained from the kinetic model and the different runs are then fit, using a least squares regression, to two second order metamodels of the form described above in equation 4, using one metamodel per response. The ensuing mathematical programming model will contain the metamodel of the cure time (t_{c}) as a function of the initiator level (I_{L}) and the wall (mold) temperature (T_{w}) as the objective function to be minimized subject to the metamodel of the flow time (t_{f}) being larger than the pre-specified level (Step 126 of FIG. 6).

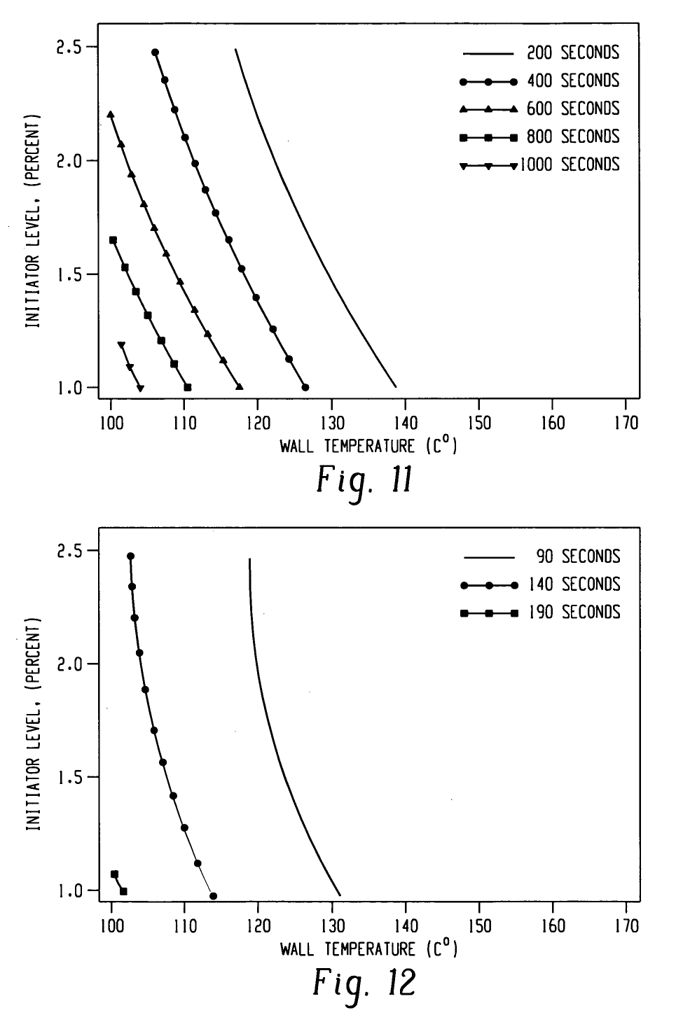

In one embodiment, an experimental design consisting of 16 experimental points that included combinations of T_{w} and I_{L} at 4 levels of each was performed, taking t_{f} and t_{c} as responses of interest. FIGS. 11 and 12 are contour plots for t_{c} and t_{f}, respectively, as a function of I_{L} and T_{w} using this design.

For the optimization, the expression for t_{c} was used as the objective function to be minimized subject to t_{f} being larger than or equal to 10, 20 and 30 seconds. The t_{f} values chosen here are typical for a small automobile hood, a large hood and a truck hood, respectively. The optimization process was started at both the lowest and the highest values of T_{w} and I_{L} and in both cases the solution converged to the values shown in Table 2.

TABLE 2
Optimized Values for I_{L} and T_{w} for Different t_{f} Values

| t_{f} = 10 s | | t_{f} = 20 s | | t_{f} = 30 s | |
|---|---|---|---|---|---|
| I_{L} | T_{w} | I_{L} | T_{w} | I_{L} | T_{w} |
| 2.5% | 170° C. | 2.5% | 149.27° C. | 2.5% | 132.02° C. |

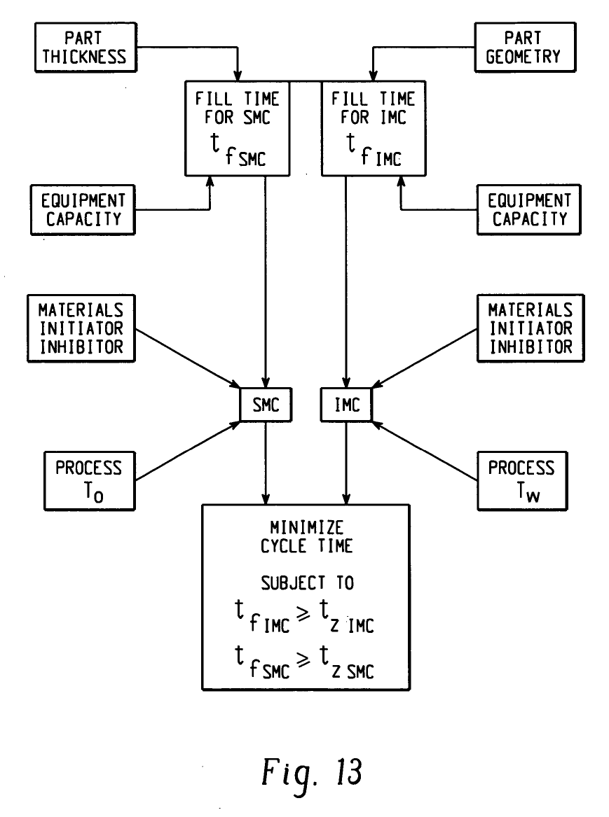

In the exemplary case, the optimal values can be deduced simply by looking at the contour plots of FIGS. 11 and 12. Thus, the minimum t_{c} value for a given minimum t_{f} will be found for the 2.5% initiator level at the maximum allowed wall temperature. In actual practice, the optimization should be applied to both the thermoplastic and IMC cycle times simultaneously as outlined in FIG. 13, which shows the process using a sheet molding compound (SMC) as the thermoplastic.

Optimal Location of IMC Injection Port

Another key to optimizing the IMC process is to be able to predict the fill pattern of the IMC, so as to locate the injection nozzle or nozzles in locations where the potential for surface defects in the appearance region of the part are minimized while decreasing the time for complete flow coverage of the IMC over the thermoplastic substrate.

The present invention presents a method for optimizing the IMC process by predicting the fill pattern of the IMC and using this pattern to determine the most beneficial placement of the IMC injection nozzle(s) in the mold. Such a process can be accomplished using mathematical modeling for a simple geometric part, which can then be extended to more complicated parts.

One Dimensional (1D) IMC Mathematical Modeling

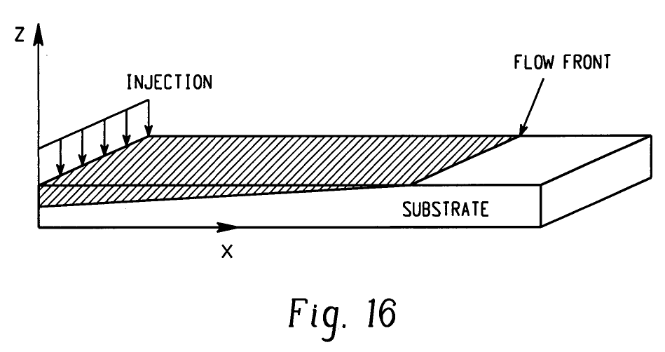

For a simple rectangular part, the coating flow from a line injection port can be approximated as 1D flow as shown in FIG. 16. The 1D mathematical model with boundary conditions under basic assumptions is established for the filling and packing stages of IMC. The following assumptions are made:

1) Isothermal flow;

2) It was found experimentally that the viscosity of the typical coating material can be represented with the power law as:

η=m[(1/2II_{Δ})^{1/2}]ⁿ⁻¹ (5)

where m and n are zero-shear rate viscosity and flow index, respectively. II_{Δ} is the second invariant of the rate-of-deformation tensor;

3) Quasi-steady-state flow with inertial terms neglected;

4) Lubrication approximation;

5) The thickness change of the thermoplastic substrate, which is the coating thickness, can be expressed as:

h=hₛ(1−V/V₀) (6)

where hₛ is the original thickness of the thermoplastic substrate right before the IMC injection; V is the specific volume of the thermoplastic substrate and is a function of pressure:

V=f(p) (7)

Under the assumption of isothermal flow, V₀ is the specific volume of the thermoplastic substrate right before the coating injection starts, i.e. under the packing pressure of the thermoplastic substrate;

6) Due to the fact that enough inhibitor is added to the coating, the inhibition time t₂ is larger than filling time t_{f}, and chemical reaction can be neglected in the filling and packing stages;

Based on the above assumptions and with the application of an order of magnitude analysis, the momentum balance equation for a section with length of dx can be simplified as:

$$\frac{\partial p}{\partial x} = \frac{\partial }{{\partial }_{z}} [ {m ( \frac{\partial v}{\partial z} )}^{n} ] \qquad ( 8 )$$

Boundary conditions are given by:

$$z = 0 ; v = 0 \\ z = h / 2 , \frac{\partial v}{\partial z} = 0 \qquad ( 9 )$$

Integrating Eq. (8) with respect to z from 0 to h by using the boundary conditions, the relation between the pressure gradient and the flow rate for any given location x is obtained:

$$\frac{\partial p}{\partial x} = - \frac{{{q}_{x}^{n} ( \frac{1}{n} + 2 )}^{n} m}{{2}^{n} {( h / 2 )}^{1 + 2 n}} \qquad ( 10 )$$

where the flow rate qₓ, is given by:

$${q}_{x} t = {\int }_{0}^{{x}_{f}} h ⅆ x \qquad ( 11 )$$

Here x_{f} is the location of the flow front and t is the filling time.

Since coating thickness is a function of specific volume that is related to pressure, equation (10) needs to be solved numerically. The finite difference method is employed here. In this method, a fixed spatial step is used to track the flow front location. For each time step, the flow front location is advanced by one spatial step, and then the pressure distribution and the coating thickness distribution are obtained by iterative solution of Eqs. (6), (7) and (10). Then, the time step can be determined by Eq. (11). The whole procedure is repeated until filling is completed.

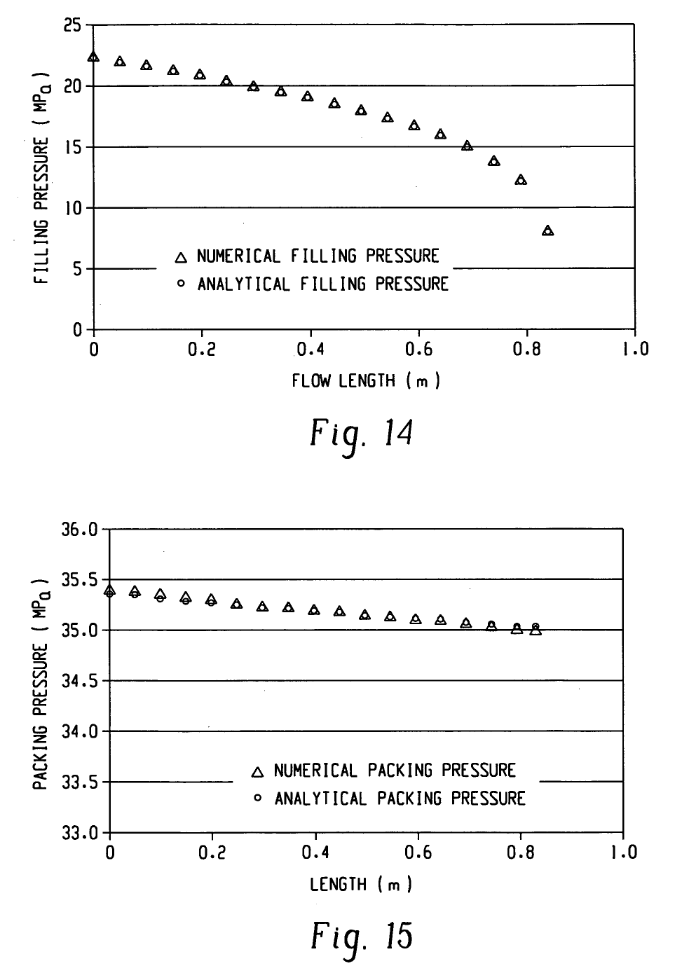

If a linear relation for the pressure and the thickness change of the substrate is assumed, an analytical solution is available for verifying the numerical solution. An exemplary analytical solution framework is disclosed in K. S. Zuyev, Chemorheology of In-Mold Coating Systems, M. S. Thesis, Ohio State University, 38-47 (2001). FIG. 14 shows the comparison between the numerically solved pressure distribution and the analytical one at the end of the IMC filling stage. The part is a rectangular plate with length 0.835 m, width 0.158 m and thickness 0.003 m. The packing pressure is 8 Mpa and the coating is injected when the thermoplastic temperature is 140° C. The flow rate of the coating injection is 2.96e-06 m³/sec. It can be seen that the results agree very well.

More coating material is injected into the mold during the packing stage until the desired coating volume is injected. FIG. 15 shows the comparison between the numerically solved packing pressure and the analytical solved packing pressure at the end of the packing stage. It can be seen results also agree well with each other. It has been shown that the analytical solution compares well with 1D experiments.

Since most of thermoplastic parts are of more complicated geometry, a more realistic mathematical model is required. The above 1D model is being extended to model the IMC for the real parts.

Since coating thickness is very small compared with the dimensions in the other two directions, the generally used Hele-Shaw model can be solved to model two dimensional IMC. The governing equations are:

$$\begin{matrix}\frac{\partial p}{\partial x} = \frac{\partial }{\partial z} ( η \frac{\partial {v}_{x}}{\partial z} ) & ( 12 ) \\ \frac{\partial p}{\partial y} = \frac{\partial }{\partial z} ( η \frac{\partial {v}_{y}}{\partial z} ) & ( 13 )\end{matrix}$$

By integration, we get:

$$\begin{matrix}{\overline{v}}_{x} = - \frac{S}{h} \frac{\partial p}{\partial x} & ( 14 ) \\ {\overline{v}}_{y} = - \frac{S}{h} \frac{\partial p}{\partial y} \\ where & ( 15 ) \\ S ( x , y ) = {\int }_{0}^{h} \frac{{z}^{2}}{η ( x , y , z )} ⅆ z & ( 16 )\end{matrix}$$

is the fluidity which represents the non-linear ratio between the local flow rate and the pressure gradient. From equation (12) and (13) it can be derived that:

τ=Λ|z| (17)

where

$$Λ = \sqrt{{( \frac{\partial p}{\partial x} )}^{2} + {( \frac{\partial p}{\partial y} )}^{2}} \qquad ( 18 )$$

and also,

τ=m\dot{γ}ⁿ (19)

From equations (18) and (19) it can be concluded that:

$$\dot{γ} = {( \frac{Λ \vert z \vert}{m} )}^{\frac{1}{n}} \qquad ( 20 )$$

substituting equation (20) into equation (16), the fluidity can be expressed as:

$$S = \frac{{Λ}^{\frac{1}{n} - 1} {h}^{\frac{1}{n} + 2}}{( \frac{1}{n} + 2 ) {m}^{\frac{1}{n}}} \qquad ( 21 )$$

From equations (12), (13), and (21), it can be seen that the fluidity S depends on the pressure gradient and the coating thickness depends on the pressure. Finite Element Method combined with Control Volume approach (FEM/CV) can be used to solve these nonlinear partial differential equations numerically.

In one embodiment of the present invention, the above described mathematical operations are performed by a computer using software developed to carry out the noted operations. The software code necessary to implement the algorithms and steps described above is within the skill of those in the art. The data necessary to perform the noted calculations and steps may be manually input by a user or it may automatically be entered by allowing communication between the computer and, for example, the instrument taking and recording the DSC measurements. The data recorded in these measurements can be stored in a data collection means, such as a hard drive, attached to the instrument. These measurements can then be relayed to the computer on which the program is stored.

In another embodiment of the present invention, a computer readable medium containing instructions for controlling a computer system to minimize the cure time of an IMC by optimizing the mold temperature and the initiator level present in the IMC for a given flow time is provided. In still another embodiment, the computer readable medium can contain additional instructions for determining the optimal location of the IMC injection port on a mold based on predicting the fill pattern of a mold.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A method for minimizing the cure time of a thermoset in-mold coating for a molded article, said method comprising the steps of:
gathering information on the reactivity of said thermoset;
using said information to develop a theoretical kinetic model representing a cure rate of said thermoset as a function of temperature and an initiator level in the coating;
fitting results obtained from said theoretical kinetic model to a metamodel of the cure time as a function of an initiator level and reaction temperature; and
minimizing said cure time using said metamodel for a minimum specified flow time.

2. The method according to claim 1, wherein said theoretical kinetic model is a free radical based kinetic model.

3. The method according to claim 1, wherein said step of gathering information on the reactivity of the thermoset is performed by conducting differential scanning calorimetry scans on said thermoset.

4. The method according to claim 1, where said kinetic model is used to generate flow time and cure time of said thermoset as functions of mold temperature and initiator level in said thermoset.

5. The method according to claim 1, wherein instructions for carrying out said method are contained in computer readable medium format.

6. A method for optimizing the location of an in-mold coating injection port in a mold so as to minimize the flow time for an in-mold coating to flow over at least a part of a molded article, said method comprising the steps of:
predicting a coating fill pattern in said mold; and
using said pattern to determine optimal placement of a coating injection nozzle so as to minimize the flow time for an in-mold coating to flow over at least a part of a molded article and to reduce the presence of surface defects of said coating.

7. The method according to claim 6, wherein said step of predicting a coating fill pattern in said mold is performed by determining the relation between a pressure in said mold and a flow rate of said coating.

8. The method according to claim 6, wherein said step of predicting a coating fill pattern in said mold is performed by determining the relation between a pressure in said mold and a coating thickness on said substrate.

9. The method according to claim 6, wherein the relation between a fluidity of said coating and a pressure gradient in said mold and the relation between a coating thickness and a pressure in said mold is determined.

10. The method according to claim 6, wherein instructions for carrying out said method are contained in computer readable medium format.
